(19) United States
(12) Patent Application Publication
(10) Pub. No.: US 2005/0219170 A1
(43) Pub. Date: Oct. 6, 2005

(54) Drive device and drive method of light emitting display panel

(75) Inventor: Shuichi Seki, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 11/093,053

(22) Filed: Mar. 30, 2005

(30) Foreign Application Priority Data
Mar. 31, 2004 (JP) 2004-104101

(51) Int. Cl. G09G 3/30

(52) U.S. Cl. 345/77

(57) ABSTRACT

In a drive device of a light emitting display panel by a pixel structure of a SES drive method comprising an organic EL element E1 as a light emitting element, a light emission drive transistor Tr1, a scan selection transistor Tr2, and an erase transistor Tr3, in order to remove electrical charges accumulated in the EL element E1, a reset transistor Tr4 is arranged between both terminals of the EL element E1 in parallel thereto, and the gate of the reset transistor is commonly connected to the gate of the erase transistor. With this structure, the erase transistor Tr3 and the reset transistor Tr4 are both turned on by an erase signal from an erase driver so that electrical charges accumulated in the EL element E1 and electrical charges of a light emission maintaining capacitor can be discharged at the same time. Thus, a rising characteristic of light emission of the EL element E1 in each subframe can be made nearly uniform. Therefore, variations of light emission intensities of respective EL elements E1 can be restrained, and precision of gradation control can be improved.

### BACKGROUND OF THE INVENTION

1. Field of the Invention

The present invention relates to a drive device of a light emitting display panel which actively drives a light emitting element constituting a pixel for example by a TFT (thin film transistor) and specifically to a drive device and a drive method of a light emitting display panel which can improve accuracy of gradation expression.

2. Description of the Related Art

A display employing a light emitting display panel constructed by arranging light emitting elements in a matrix pattern has been developed widely. As a light emitting element employed in such a display panel, for example an organic EL (electroluminescent) element in which an organic material is employed in a light emitting layer has attracted attention, and a display panel employing the organic EL elements has already been put into practical use in some products. This is because of backgrounds one of which is that by employing, in the light emitting layer of the EL element, an organic compound which enables an excellent light emission characteristic to be expected, a high efficiency and a long life which can be equal to practical use have been advanced.

The organic EL element can be electrically replaced by a structure composed of a light emitting component having a diode characteristic and a parasitic capacitance component which is connected in parallel to this light emitting component, and it can be said that the organic EL element is a capacitive light emitting element. When a light emission drive voltage is applied to this organic EL element, at first, electrical charges corresponding to the electric capacity of this element flow into the electrode as a displacement current and are accumulated. It can be considered that when the light emission drive voltage then exceeds a predetermined voltage (light emission threshold voltage=Vth) peculiar to this element, current begins to flow from one electrode (anode electrode side of the diode component) to an organic layer constituting the light emitting layer so that the element emits light at an intensity proportional to this current.

As a display panel employing such organic EL elements, a passive matrix type display panel in which EL elements are simply arranged in a matrix pattern and an active matrix type display panel in which respective active elements for example constituted by TFTs are added to respective EL elements arranged in a matrix pattern have been proposed. The latter active matrix type display panel can realize low power consumption compared to the former passive matrix type display panel and has a characteristic that crosstalk among pixels is small and the like, whereby it is particularly suitable for a high definition display constituting a large screen.

FIG. 1 shows an example of a circuit structure corresponding to one pixel 10 in an already proposed active matrix type display panel. The structure of the pixel 10 shown in this FIG. 1 shows an example in which a lighting drive method called simultaneous erasing scan (SES) method which realizes time division gradation expression is adopted.

In the structure of this pixel 10, a data signal Vdata which is supplied from a data driver 11 and which corresponds to a video signal is supplied to source S of a scan selection transistor, that is, a data write transistor (hereinafter simply referred to as a write transistor as well) Tr2 via a data line arranged in the display panel. A scan signal Select is supplied from a scan driver 12 to gate G of the write transistor Tr2 via a scan selection line.

Drain D of the write transistor Tr2 is connected to gate G of a light emission drive transistor Tr1 (hereinafter simply referred to a drive transistor as well) and to one terminal of a light emission maintaining capacitor C1. Source S of the drive transistor Tr1 is connected to the other terminal of the capacitor C1 and to a drive power source Vcc. Further, drain D of the drive transistor Tr1 is connected to the anode terminal of an organic EL element E1 provided as a light emitting element, and the cathode terminal of this organic EL element E1 is connected to a reference potential point (ground).

An erase signal Erase is supplied from an erase driver 13 to the gate of an erase transistor Tr3 via an erase signal line. Respective terminal portions of the capacitor C1 are connected to respective source S and drain D of the erase transistor Tr3. In the pixel 10 shown in FIG. 1, only the drive transistor Tr1 is constituted by a p-channel type TFT, and other transistors are constituted by n-channel type TFTs. A large number of pixels 10 of the above-described structure are arranged in a matrix pattern in row and column directions to construct the display panel.

In the structure of the pixel 10 shown in FIG. 1, an ON voltage Select as the scan signal is supplied from the scan driver 12 to the gate of the write transistor Tr2 during an address period. Thus, current corresponding to the data signal Vdata supplied from the data driver 11 flows into the capacitor C1 via the source and drain of the write transistor Tr2 so that the capacitor C1 is charged. The charge voltage is supplied to the gate of the drive transistor Tr1, and the transistor Tr1 allows current corresponding to its gate voltage and the drive power source Vcc supplied to the drain to flow in the EL element E1, whereby the EL element E1 emits light.

When the address period elapses and the gate of the write transistor Tr2 becomes an OFF voltage, the transistor Tr2 becomes in a so-called cutoff state. However, the gate voltage of the drive transistor Tr1 is maintained by electrical charges accumulated in the capacitor C1, and thus drive current into the EL element E1 is maintained. Accordingly, the EL element E1 can continue a lighting state corresponding to the data signal Vdata until a period performing the next address operation (for example, a next one subframe period).

Meanwhile, in the middle of a lighting period of the EL element E1 (for example, in the middle of one subframe period), the erasing signal Erase which allows the erase transistor Tr3 to be turned on is supplied from the erase driver 13, and thus electrical charges charged in the capacitor C1 are erased (discharged). As a result, the drive transistor Tr1 becomes in the cutoff state, and the EL element E1 is immediately extinguished. In other words, by controlling output timing of the gate ON voltage supplied from the erase driver 13, the lighting period of the EL element E1 is controlled, and thus multi-gradation expression can be realized.

FIG. 2 shows one example of gradation control performed in a display panel with a pixel structure of the above-mentioned SES drive method. As shown in FIG. 2, corresponding to respective gradation bits of “5”-“0”, the number of subframes is allocated as a weight. In the case where for example gradation bits is “5”, four subframes are allocated, and in the case where for example gradation bit is “0”, ⅛ subframe is allocated.

One frame period is divided into 10 subframes and one dummy subframe (DM) as shown by subframe numbers “1”-“10”. Further, gradation bits are allocated for each subframe, and for example, gradation bit “5” is allocated to four subframes, that is, subframe numbers, “2”, “5”, “7”, and “9”, during one frame period. Meanwhile, for example, gradation bit “10” is allocated to subframe number “10” during one frame period as ⅛ weight.

Therefore, in a first subframe, a third gradation bit is allocated, and a lighting operation of weight 1 of subframe is executed. Thus, at the start time of the first subframe, from the scan driver 12 shown in FIG. 1, a scan signal, that is, a write start pulse shown in FIG. 2, is supplied to the gate of the write transistor Tr2, and the capacitor C1 is charged based on the data signal Vdata supplied from the data driver 11. Based on this charge voltage, the drive transistor Tr3 supplies drive current to the EL element E1, and by this the EL element E1 is driven to emit light.

In the next second subframe, a fifth gradation bit is allocated, and a lighting operation of weight 1 of subframe is executed similarly. The operation of this time is similar to the operation in the above-described first subframe. Further, in the next third subframe, a second gradation bit is allocated, and in this case, a lighting operation of ½ of a subframe period is performed. That is, at the start time of the third subframe, the write start pulse is supplied. When ½ of this subframe elapses, an erase start pulse (the erase signal) is supplied from the erase driver 13 shown in FIG. 1, and by this, the erase transistor Tr3 is turned on.

Therefore, electrical charges accumulated in the capacitor C1 are discharged, and the drive transistor Tr1 is cutoff immediately so that the EL element E1 is extinguished. Even after a fourth subframe, by an operation similar to the above, lighting control for the EL element based on the weight allocated for each subframe is executed, and 64 gradations of gradation control can be executed in accordance with the example shown in this FIG. 2. During the above-mentioned dummy subframe (DM) period, in order to prolong the light emission lifetime of the EL element, an operation of applying a reverse bias voltage to the EL element is executed.

FIG. 3 shows an example of gradation control by a no weight subframe method performed in a display panel provided with the pixel structures of the above-mentioned SES drive method. In the gradation control shown in this FIG. 3, one frame period is divided into 10 subframe periods and two dummy subframe (DM) periods. In the example shown in FIG. 3, at respective start points of first to tenth subframes, the write start pulse is outputted, thereby the write transistor Tr2 shown in FIG. 1 is brought to an ON state so that a write operation to the capacitor C1 is executed.

Meanwhile, in the example shown in FIG. 3, at the point of time up to the dummy subframe, the erase start pulse is outputted, then the erase transistor Tr3 is turned on so that the EL element E1 is controlled to be brought to a non-lighting state. During the two dummy subframe periods, similarly to the example shown in FIG. 2, an operation of applying the reverse bias voltage to the EL element is executed in order to prolong the light emission lifetime of the EL element during these period. In the example shown in FIG. 3, gradation control of 10 gradations can be performed.

Organic EL elements as light emitting elements constituting respective pixels are capacitive light emitting elements as described earlier, and in the case where light emission drive is performed during one subframe period, a phenomenon in which light emission intensities are different occurs depending on whether or not light emission drive is performed during its prior subframe period. That is, in the case where light emission drive is performed during a subframe period before one subframe period, electrical charges have been accumulated in the parasitic capacitance of the EL element in the forward direction, and thus rising of light emission during the next subframe is extremely fast. In other words, the EL element is continuously brought to a light emission state.

With respect to this, in the case where the EL element is not driven to emit light during a subframe period before one subframe period, the amount of electrical charges accumulated in the parasitic capacitance of the EL element is small, and light emission drive current is consumed for charging the parasitic capacitance at the beginning of the next subframe period so that rising of light emission of the EL element is delayed a little bit. Therefore, a problem that the light emission intensity in this subframe period is substantially decreased is brought about.

The above-described phenomenon occurs similarly in the gradation control of the weighting subframe method shown in FIG. 2 and also in the gradation control of the no weight subframe method shown in FIG. 3. With respect to the above-described phenomenon, variations occur individually in accordance with periods during which the EL elements are extinguished, and there is a problem that accuracy of gradation control is deteriorated.

In order to dissolve such a problem, a structure in which both electrodes of an EL element are short circuited for example for each frame to discharge electrical charges accumulated in the parasitic capacitance each time those are short circuited in order to improve the precision of gradation control is disclosed Japanese Patent No. 3259774 and Japanese Patent Application Laid-Open No. 2003-173154 shown below.

Meanwhile, in the structure shown in Japanese Patent No. 3259774, provided is a switching transistor that discharges electrical charges accumulated in the parasitic capacitance of an EL element in a next scan line while utilizing a scan voltage applied to a scan line before the next scan line which becomes a scan target. With this structure, since electrical charges accumulated in the parasitic capacitance of the EL element can be discharged immediately before it becomes the scan target, variations in light emission intensities of EL elements can be prevented from occurring.

Although discharging electrical charges accumulated in the parasitic capacitances of EL elements individually immediately before it becomes the scan target as described above is effective from the standpoint that variations of light emission intensities of EL elements are restricted, on the other hand since there is no choice but to discharge the electrical charges anyway, a problem that utilization efficiency of a power source is sacrificed occurs. The above-described precision improvement of gradation expression and utilization efficiency of a power source are diametrically opposed technical problems, and in circumstances in which subtle gradation expression cannot be recognized with the naked eye of a human being such as in a case where for example a dimmer display is controlled to be in a low state (a state in which an image display is dark), rather it is important to make a selection so as to improve utilization efficiency of a power source.

Meanwhile, in the structure shown in Japanese Patent Application Laid-Open No. 2003-173154, provided is a switching transistor which discharges electrical charges accumulated in the parasitic capacitance of an EL element, and disposed is a control line for the exclusive use of driving this switching transistor. With this structure, although electrical charges accumulated in an EL element can be discharged at predetermined timing, a problem that the above-mentioned control line for the exclusive use has to be disposed on a display panel occurs.

Further, in a case where precise gradation expression is to be realized, it is desired to discharge the gate of a light emission drive transistor and also electrical charges of a light emission maintaining capacitor C1 connected thereto on all such occasions.

### SUMMARY OF THE INVENTION

The present invention has been developed based on the above-described technical viewpoint, and it is an object of the present invention to provide a drive device and a drive method of a light emitting display panel constructed in such a way that gradation expression with higher accuracy is realized by simultaneously discharging electrical charges accumulated in the parasitic capacitance of an EL element as well as the gate of a drive transistor and electrical charges of a light emission maintaining capacitor for example for each subframe and that whether this discharge operation is executed or not can be selected easily without increasing the circuit size.

A drive device of a light emitting display panel according to the present invention which has been developed to solve the above problems is a drive device of an active matrix type light emitting display panel comprising a light emitting element, a light emission drive transistor, a scan selection transistor, and an erase transistor, each of which is arranged at intersecting positions between a plurality of data lines and a plurality of scan selection lines, characterized in that in order to remove electrical charges accumulated in the light emitting element, a reset transistor is arranged between both terminals of the light emitting element in parallel thereto, and the gate of the reset transistor is connected to a control line of the erase transistor.

Meanwhile, a drive method of one form according to the present invention which has been developed to solve the above problems is a drive method of an active matrix type light emitting display panel comprising a light emitting element, a light emission drive transistor, a scan selection transistor, and an erase transistor, each of which is arranged at intersecting positions between a plurality of data lines and a plurality of scan selection lines, characterized in that in order to remove electrical charges accumulated in the light emitting element, a reset transistor is arranged between both terminals of the light emitting element in parallel thereto, wherein the reset transistor and the erase transistor are controlled to be turned on and off at a same timing, and in a case where the light emitting element is controlled to be lit over respective subframe periods, the reset transistor and the erase transistor are both controlled to be in an ON state at timing of switching of the subframe.

Further, a drive method of another form according to the present invention which has been developed to solve the above problems is a drive method of an active matrix type light emitting display panel comprising a light emitting element, a light emission drive transistor, a scan selection transistor, and an erase transistor, each of which is arranged at intersecting positions between a plurality of data lines and a plurality of scan selection lines, characterized in that in order to remove electrical charges accumulated in the light emitting element, a reset transistor is arranged between both terminals of the light emitting element in parallel thereto, and the reset transistor and the erase transistor are controlled to be turned on and off at a same timing and are controlled to be in an ON state selectively for each subframe period.

### BRIEF DESCRIPTION OF THE DRAWINGS

FIG. 1 is a connection diagram showing an example of a circuit structure corresponding to one pixel in a conventional active matrix type display panel;

FIG. 2 is a timing diagram showing an example of gradation control by a weighted subframe method performed in a display panel provided with a pixel structure of a conventional SES drive method;

FIG. 3 is a timing diagram showing an example of gradation control by a no weight subframe method performed similarly;

FIG. 4 is a circuit structure diagram explaining a respective electrical potential relationship of a reset state in a light emission display pixel appropriately utilized in the present invention;

FIG. 5 is a circuit structure diagram explaining a respective electrical potential relationship of a data write state similarly;

FIG. 6 is a circuit structure diagram explaining a respective electrical potential relationship of a data holding state similarly;

FIG. 7 is a timing diagram showing an example of operation of first gradation control performed by the circuit structure shown in FIGS. 4 to 6;

FIG. 8 is a timing diagram showing an example of operation of second gradation control similarly; and

FIG. 9 is a timing diagram showing an example of operation of third gradation control similarly.

### DESCRIPTION OF THE PREFERRED EMBODIMENTS

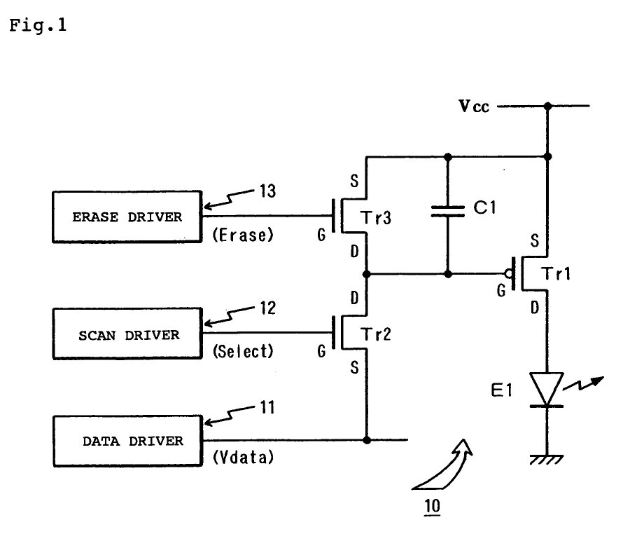

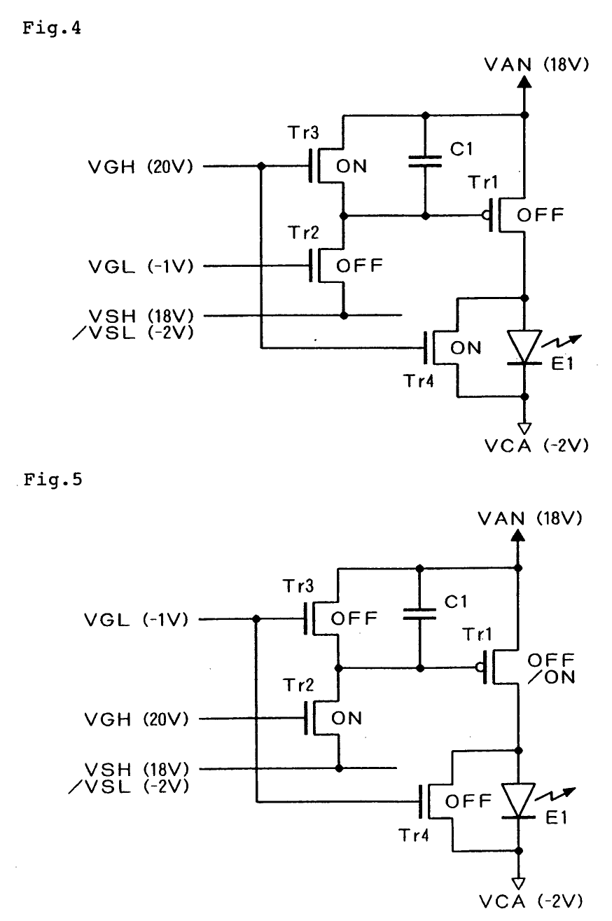

A drive device of a light emitting display panel according to the present invention will be described below with reference to an embodiment shown in the drawings. FIGS. 4 to 6 show a circuit structure of a display pixel utilized appropriately in a drive device according to the present invention, and FIGS. 4 to 6 show a reset state, a data write state, a data holding state, respectively. In the structure shown in FIGS. 4 to 6, a reset transistor Tr4 by an n-channel type TFT is added to the pixel structure of an SES drive method shown in FIG. 1 already described. The drain and source of the reset transistor Tr4 are connected to the anode and cathode of an EL element E1, respectively, and the gate thereof is commonly connected to the control line of an erase transistor Tr3, that is, to the gate of the erase transistor Tr3.

As electrical potentials at respective portions are exemplified in respective FIGS. 4 to 6, in these embodiments, 18 volts shown as VAN is supplied to the source of a drive transistor Tr1, and −2 volts shown as VCA is supplied to the cathode side of the EL element E1. VSH (18 volts) or VSL (−2 volts) is supplied as a data signal from the data driver to the source of a write transistor Tr2.

In the reset state shown in FIG. 4, VGL (−1 volt) is supplied from a scan driver to the gate of the write transistor Tr2, and VGH (20 volts) is supplied from an erase driver to the respective gates of the erase transistor Tr3 and the reset transistor Tr4. As a result, the write transistor Tr2 is turned off, and the erase transistor Tr3 and the reset transistor Tr4 are turned on. Thus, electrical charges accumulated in the capacitor C1 are discharged by the erase transistor Tr3, and as a result, the drive transistor Tr1 is also turned off. By the on operation of the reset transistor Tr4, electrical charges accumulated in the parasitic capacitor of the EL element E1 are discharged to be in a reset state.

In the data write state shown in FIG. 5, VGH is supplied to the gate of the write transistor Tr2, and VGL is supplied to the respective gates of the erase transistor Tr3 and the reset transistor Tr4. As a result, the erase transistor Tr3 and the reset transistor Tr4 are both turned off, and the write transistor Tr2 is turned on. Accordingly, at this time the electrical potential corresponding to the electrical potential of VSH or VSL supplied to the source of the write transistor Tr2 is written in the capacitor C1. Here, in the case where the electrical potential corresponding to the VSH is written in the capacitor C1, the drive transistor Tr is turned off, and in the case where the electrical potential corresponding to VSL is written in the capacitor C1, the drive transistor Tr1 is turned on.

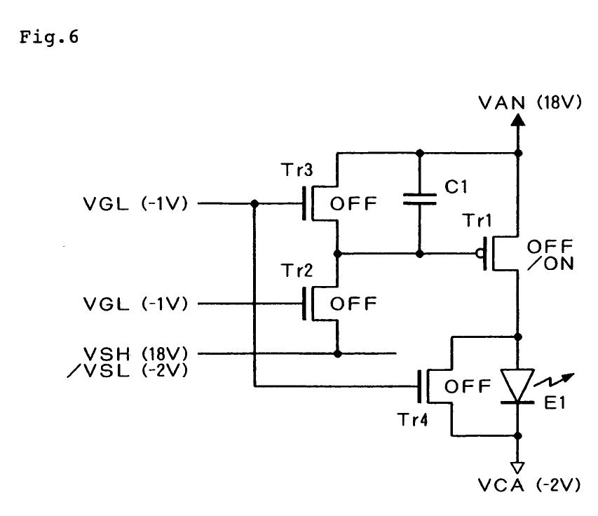

In the data holding state shown in FIG. 6, VGL is supplied to the gate of the write transistor Tr2 to be turned off. However, since a data voltage written in the capacitor C1 is supplied to the gate of the drive transistor Tr1, the drive transistor Tr1 continues an off or on operation in response to the data signal of a data write time shown in FIG. 5.

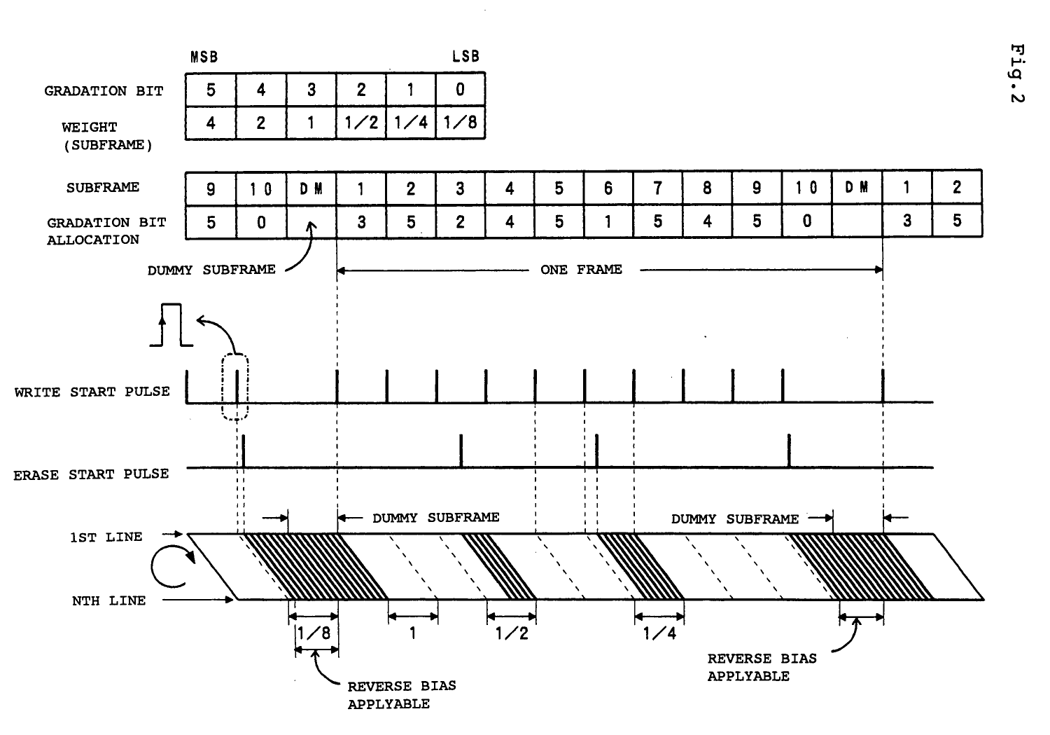

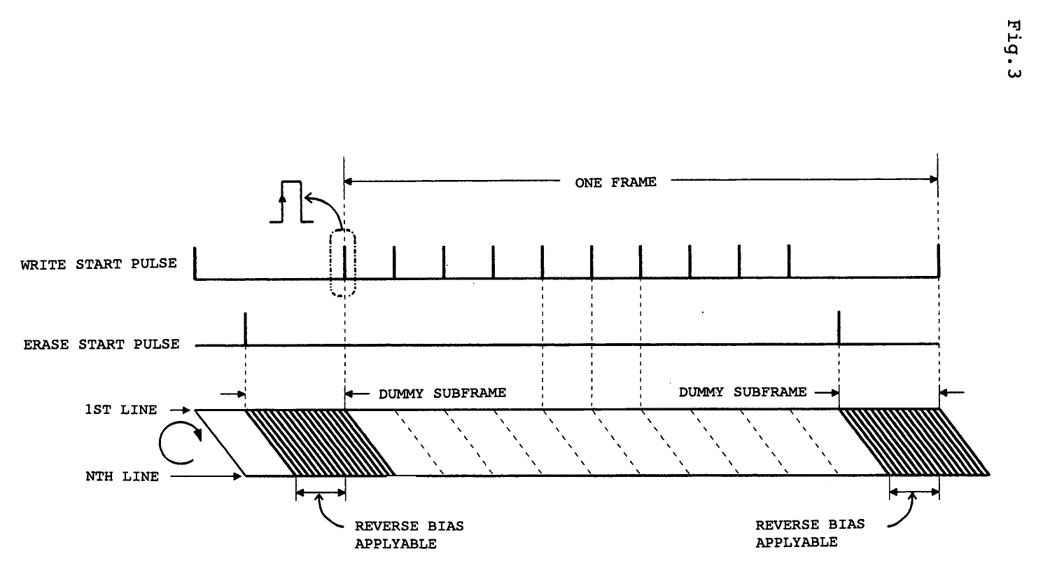

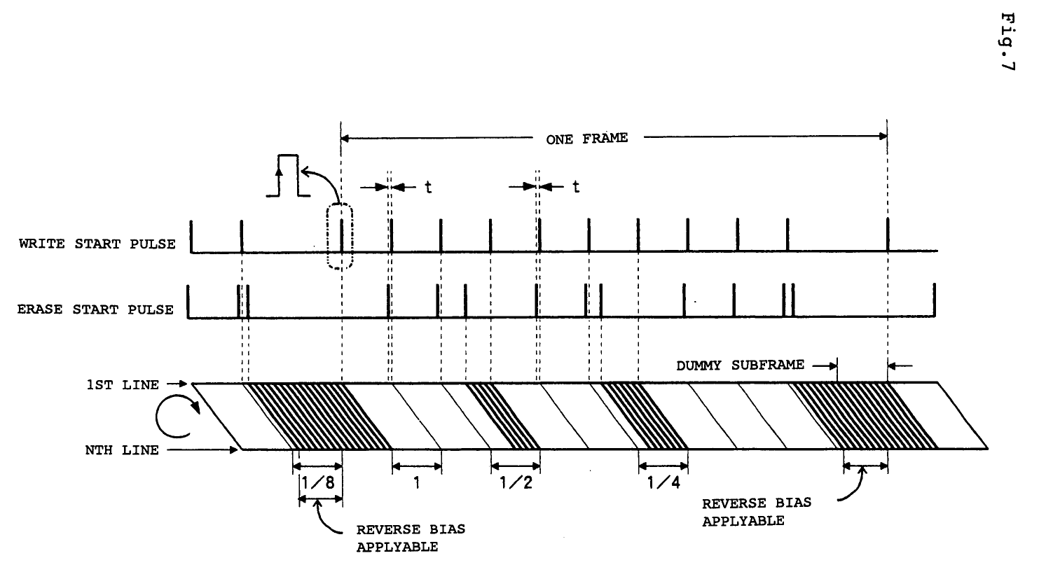

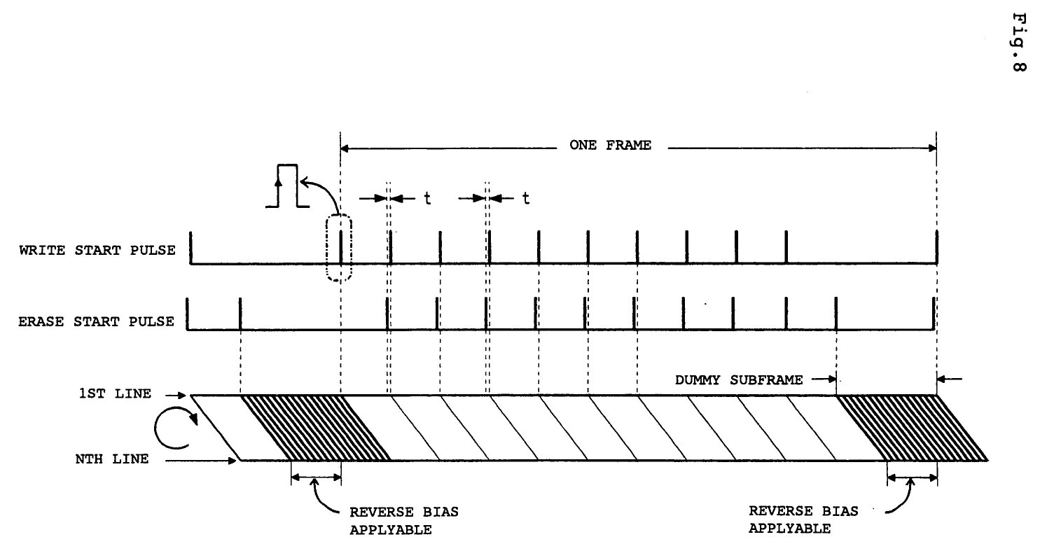

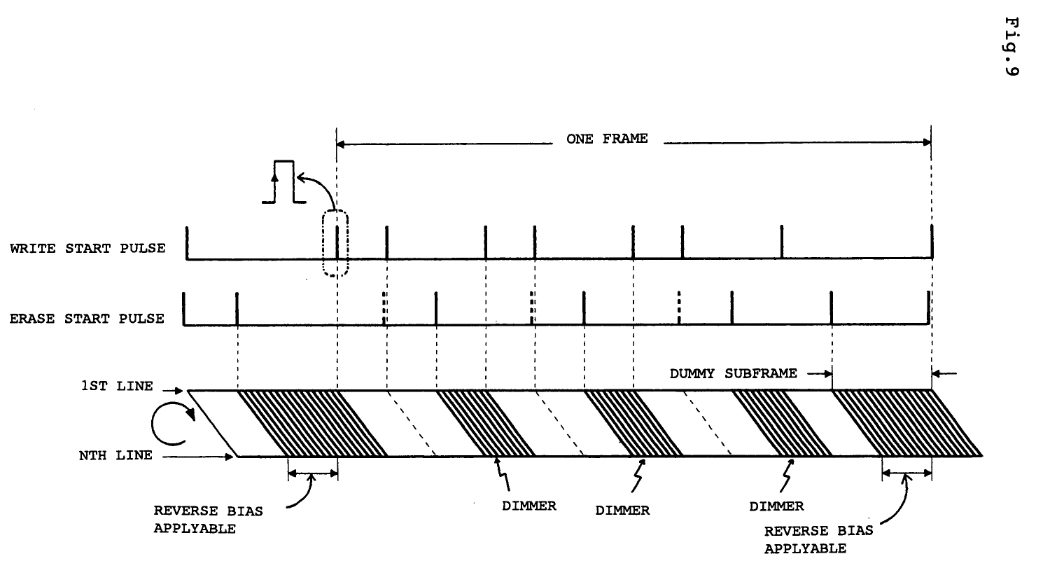

FIGS. 7 and 8 show examples of operations of gradation control performed by the embodiment shown in FIGS. 4 to 6 described above. The example shown in FIG. 7 shows an example of gradation control by the weighting subframe method, and this is to solve a technical problem in gradation control shown in FIG. 2 already described. The example shown in FIG. 8 shows an example of gradation control by a no weight subframe method, and this is to solve a technical problem in gradation control shown in FIG. 3 already described.

As gradation control shown in FIG. 7 and gradation control shown in FIG. 8 are apparent from comparison with FIG. 2 and comparison with FIG. 3, respectively, in the case where the EL element is driven to be lit over respective subframe periods, the erase start pulse is outputted from the erase driver at timing of switching of the subframe. Thus, the reset state described with reference to FIG. 4 is brought about.

Accordingly, by the on operation of the reset transistor Tr4, electrical charges accumulated in the parasitic capacitor of the EL element E1 are discharged to bring about the reset state, and by the on operation of the erase transistor Tr3, electrical charges accumulated in the capacitor C1 are also discharged. At the beginning of the next subframe period which follows this, that is, after time t elapses since an occurrence of the erase start pulse as shown in FIGS. 7 and 8, a write start pulse is generated, and thus lighting control of the EL element during a next subframe period is performed.

At the timing of occurrence of the write start pulse, since electrical charges in the parasitic capacitance of the EL element E1 and electrical charges of the light emission maintaining capacitor C1 are both brought to the reset (discharge) state, a rising characteristic of light emission of the EL element E1 in each subframe can be made nearly uniform. Thus, variations of light emission intensities of respective EL elements E1 can be restrained, and precision of gradation control can be improved.

FIG. 9 shows another example of gradation control by the no weight subframe method similarly to that of FIG. 8. The example shown in this FIG. 9 exemplifies a case where dimmer control is executed. That is, in circumstances in which an image display is controlled to be in a dark state by dimmer control as described above, even if high precision gradation control is executed, discriminating this is impossible by the naked eye of a human being.

Thus, in the example shown in FIG. 9, the reset operation is selectively executed in accordance with the degree of dimmer control. For example, the erase start pulse shown by broken lines in FIG. 9 is not allowed to be outputted at this timing, that is, the reset operation is not executed, and only rewriting of the data signal is executed utilizing the write start pulse. In the case where such control is executed, deterioration of utilization efficiency of electric power resulting from the reset operation can be restrained.

It is desired that the device is constructed so that whether or not the erase start pulse is generated can be selected appropriately depending on the degree of the dimmer control. For example, in the case where setting of dimmer is relatively bright, it is desired that the erase start pulse is generated for each subframe while accuracy of gradation control is prioritized, and in the case where setting of dimmer is relatively dark, it is desired that control is performed so as to restrain the erase start pulse from being generated for each subframe while utilization efficiency of electric power is prioritized.

As described above, whether the reset operation is executed or not can be realized by control of the erase driver without particularly arranging a control signal line in a light emission display panel according to the circuit structure shown in FIGS. 4 to 6 in which the SES drive method is the basis.

In the embodiment described above, although an organic EL element is employed as a light emitting element, this light emitting element is not limited to the organic EL element, and operations and effects similar to the above can be obtained even in a case where other capacitive light emitting elements are employed.

1. A drive device of an active matrix type light emitting display panel comprising a light emitting element, a light emission drive transistor, a scan selection transistor, and an erase transistor, each of which is arranged at intersecting positions between a plurality of data lines and a plurality of scan selection lines, wherein in order to remove electrical charges accumulated in the light emitting element, a reset transistor is arranged between both terminals of the light emitting element in parallel thereto, and the gate of the reset transistor is connected to a control line of the erase transistor.

2. The drive device of the light emitting display panel according to claim 1, characterized in that a capacitor maintaining a light emission state of the light emitting element is arranged at the gate of the light emission drive transistor.

3. The drive device of the light emitting display panel according to claim 1 or 2, characterized in that the light emitting element is constituted by an organic EL element in which an organic compound is employed in a light emitting layer.

4. A drive method of an active matrix type light emitting display panel comprising a light emitting element, a light emission drive transistor, a scan selection transistor, and an erase transistor, each of which is arranged at intersecting positions between a plurality of data lines and a plurality of scan selection lines, wherein in order to remove electrical charges accumulated in the light emitting element, a reset transistor is arranged between both terminals of the light emitting element in parallel thereto, wherein the reset transistor and the erase transistor are controlled to be turned on and off at a same timing, and in a case where the light emitting element is controlled to be lit over respective subframe periods, the reset transistor and the erase transistor are both controlled to be in an ON state at timing of switching of the subframe.

5. A drive method of an active matrix type light emitting display panel comprising a light emitting element, a light emission drive transistor, a scan selection transistor, and an erase transistor, each of which is arranged at intersecting positions between a plurality of data lines and a plurality of scan selection lines, wherein in order to remove electrical charges accumulated in the light emitting element, a reset transistor is arranged between both terminals of the light emitting element in parallel thereto, and the reset transistor and the erase transistor are controlled to be turned on and off at a same timing and are controlled to be in an ON state selectively for each subframe period.

6. The drive method of the light emitting display panel according to claim 5, characterized in that the reset transistor and the erase transistor are controlled to be in the ON state selectively for each subframe period in accordance with the degree of dimmer control of the light emitting display panel.
